(19) United States
(12) Patent Application Publication
(10) Pub. No.: US 2010/0060423 A1
(43) Pub. Date: Mar. 11, 2010

(54) Radio frequency identification (RFID) reader with multiple receive channels

(75) Inventor: Vijay Pillai, Fremont, CA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Intermec Technologies Corporation, Everett, WA (US)

(21) Appl. No.: 12/231,818

(22) Filed: Sep. 5, 2008

(51) Int. Cl. H04Q 5/22

(52) U.S. Cl. 340/10.1

(57) ABSTRACT

A radio-frequency identification (RFID) system includes an RFID tag, an RFID reader, and a controller. The RFID reader employs a plurality of phase-offset or phase-diverse channels to improve detection of data transmitted from the RFID tag to the RFID reader. A controller selects the channel that provides the best signal-to-noise ratio and decodes the data provided by the RFID tag using the selected channel.

### BACKGROUND

The present invention is related to radio frequency identification (RFID) and in particular to base stations having multiple receiver channels for minimizing noise.

Radio frequency identification (RFID) refers to a wireless communication method that allows information encoded on an RFID tag to be wirelessly communicated to a reader (commonly referred to as a ‘base station’). RFID tags are often-times incorporated onto packages or products for use in supply chain management and inventory control.

A variety of RFID tags are available, including active RFID tags, semi-passive-RFID tags, and passive RFID tags. Active RFID tags include a battery that supplies power to the tag as well as the power necessary to generate a transmission signal provided to a reader. Semi-passive RFID tags include a battery for supplying power to the RFID tag, but rely on power transmitted from a reader to generate a reflected signal, referred to as a ‘backscattered signal’, for communication to the reader. Passive devices rely on power transmitted from the reader for both the power consumed by the RFID tag as well as the backscattered signal generated by the RFID tag. Passive and semi-passive devices are the most common types of RFID tags, due in part to the relatively low cost of passive and semi-passive devices as compared with active devices.

In operation, a base station operates both as a specialized radio transmitter and a receiver. The base station transmits power at a relatively high frequency (e.g., 900 MegaHertz (MHz)) that is received by one or more RFID tags. A portion of the transmitted signal is reflected back by the RFID tag, wherein the RFID tag encodes information onto the transmitted signal by modulating the impedance (e.g., real impedance or reactance) of the tag antenna. This has the effect of changing the phase and/or amplitude of the backscattered signal received by the reader.

The reader senses the backscattered signal provided by the RFID tag and through a series of mixing and filtering steps identifies the information encoded onto the backscattered signal. A reader typically divides the received backscattered signal into two channels (commonly referred to as the I and Q channel) having a phase difference relative to one another. For instance, the I channel is generated by mixing a local oscillation (LO) signal with the backscattered signal. Likewise, the Q channel is generated by mixing a LO signal having a phase offset of 90 degrees relative to the original LO signal with the backscattered signal. In this way, regardless of the phase of the incoming backscattered signal (which varies based on the distance of the base station from the RFID tag), the backscattered signal can be recovered.

Depending on the location of the RFID tag in relation with the RFID reader, the backscattered signal may be distributed between the I and Q channels. However, noise (typically due to reflection at the antenna) may also be distributed between the I and Q channels. As a result, the signal-to-noise ratio (SNR) for a particular channel depends not only on the distribution of the backscattered signal between the two channels, but also on the distribution of noise between the two channels. For instance, the backscattered signal may be distributed almost entirely on the I channel. However, the SNR may still be poor because most of the noise power is also distributed on the I channel.

The present invention is therefore directed towards a system and method for overcoming these obstacles.

### SUMMARY

A radio-frequency identification (RFID) system includes an RFID tag, an RFID reader, and a controller. The RFID tag includes an antenna for receiving and reflected transmitted signals. The RFID read includes at least on antenna for receiving and transmitting signals and a plurality of phase-diverse channels communicatively coupled to the receiving antenna for processing received signals. Each phase-diverse channel employs a mixer for mixing a received signal with a local oscillator (LO) signal phase-shifted with respect to each of the plurality of channels. The controller is communicatively coupled to the RFID reader for receiving the signals processed by each of the plurality of phase-diverse channels, and decodes data provided by the RFID tag based on the processed signals provided by the plurality of phase-diverse channels.

### BRIEF DESCRIPTION OF THE DRAWINGS

FIG. 1 is a block diagram illustrating communication between a radio frequency identification (RFID) reader and RFID tag.

FIG. 2 is a block diagram of a channel diverse RFID reader according to an embodiment of the present invention.

FIG. 3 is a flowchart illustrating operations performed by a controller in selecting a channel according to an exemplary embodiment of the present invention.

### DETAILED DESCRIPTION

An RFID reader of the present invention makes use of a plurality of channels operating out of phase with one another (i.e., channel diversity) to improve decoding and detection of data communicated by an RFID tag.

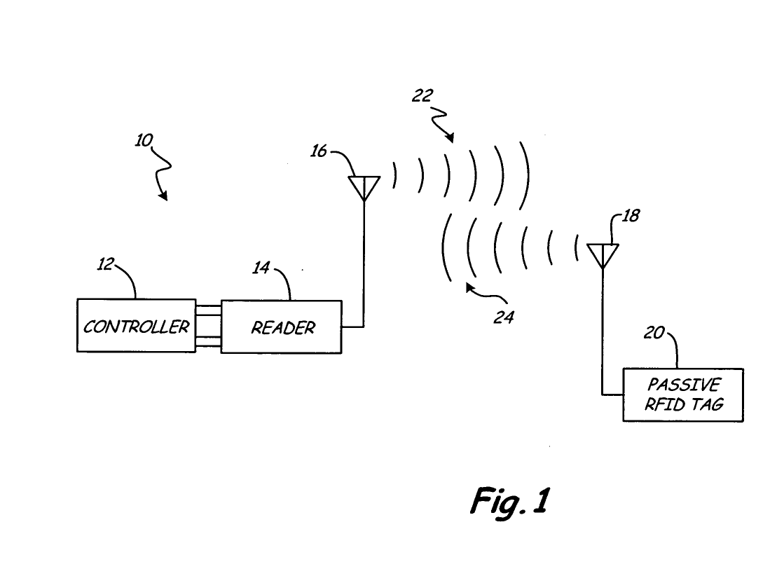

FIG. 1 is a block diagram illustrating an exemplary embodiment of an RFID communication system 10, which includes controller 12, RFID reader 14, reader antenna 16, tag antenna 18, and passive RFID tag 20. In this exemplary embodiment, RFID tag 20 is a passive tag, relying on power transmitted by reader antenna (labeled ‘22’) to supply power to systems on-board RFID tag 20 and to generate a backscattered signal (labeled ‘24’) for transmission back to reader antenna 16. In other embodiments, semi-passive or active RFID tags, which employ batteries to supply various levels of power to the RFID tag, can be employed in lieu of the passive tag depicted in FIG. 1.

In an exemplary embodiment, controller 12 (e.g., personal computer, handheld device, etc.) instructs RFID reader 14 to generate transmission signal 22, which serves to interrogate local RFID tags. The transmission signal generated by reader 14 and provided to antenna 16 for communication is typically a high-frequency signal (i.e., carrier frequency), operating in an assigned frequency ranges (e.g., 800-1000 MegaHertz (MHz)). In the embodiment shown in FIG. 1, reader antenna 16 acts as both a transmitting antenna and a receiving antenna. That is, reader antenna 16 transmits the high-frequency transmission signal 22 at the request of controller 12 and reader 14, and also acts to receive backscattered signals 24 provided by interrogated RFID tags. In other embodiments, a separate transmission antenna and receiver antenna may be employed.

With respect to passive RFID devices, interrogation of each RFID tag begins with tag antenna 18 receiving a transmission signal generated by reader antenna 16. Power received by tag antenna 18 is rectified and used to power systems employed by RFID tag 20. In addition, a portion of the transmitted signal is reflected back towards reader antenna 16. This reflection from RFID tag 20 is referred to herein as the backscattered signal. Other forms of reflection, typically at antenna 16, represent forms of noise that oftentimes interfere with the ability of RFID reader 14 to detect data within the backscattered signal. Data or information stored by RFID tag 20 is transmitted back to RFID reader antenna 16 by modulating the backscattered signal 24. In an exemplary embodiment, RFID tag 20 modulates backscattered signal 24 by selectively varying the impedance associated with tag antenna 18. This may include varying the real impedance associated with tag antenna 18, the reactive impedance associated with tag antenna 18, or a combination thereof.

Reader antenna 16 receives backscattered signal 24. In the exemplary embodiment illustrated in FIG. 1, reader antenna 16 also serves as the receiving antenna for RFID reader 14. In other embodiments, RFID reader 14 may include separate antennas for transmitting and receiving signals. The backscattered signal 24 captured by reader antenna 16 is provided to RFID reader 14 for demodulation and detection of data provided by the interrogated RFID tag.

In addition to the backscattered signal 24 provided by RFID tag 20 and tag antenna 18, reader antenna may also be subject to a variety of noise sources. For instance, the transmission signal generated by reader antenna 16 may result in additional reflections not associated with the desired reflection of backscattered signal 24 controlled by RFID tag 20. Throughout the description, the RFID reader is described with respect to detecting the backscatter signal provided by the RFID tag (i.e., the desired signal). It is worth noting that processing of the backscatter signal will include processing of noise signals (e.g., those caused by reflection at the RFID reader antenna, etc.).

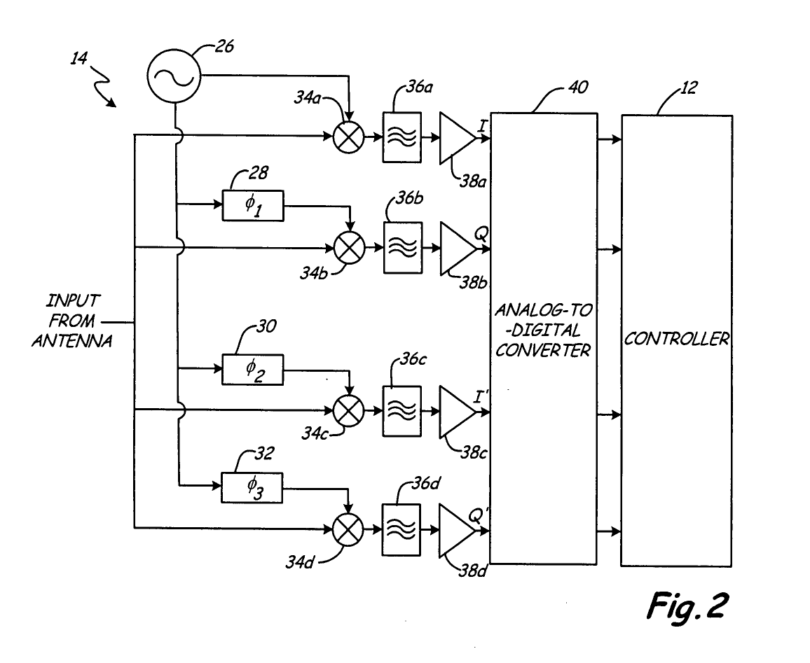

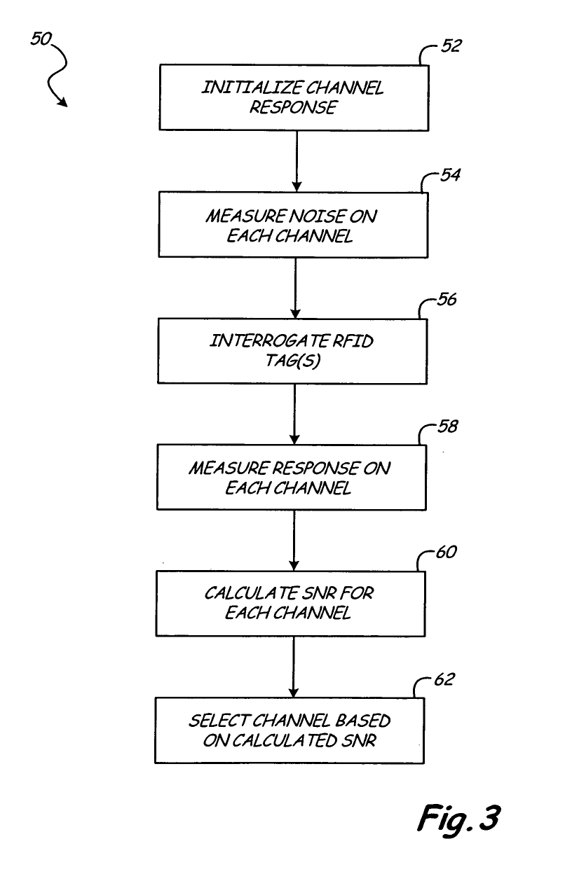

Conventional methods of demodulating backscattered signal 24, including methods of mixing backscattered signal 24 with an in-phase LO signal (i.e., I channel) as well as with an out-of-phase or quadrature LO signal (i.e., Q channel), fail to account for situations in which the presence of noise at a particular phase results in a poor signal-to-noise ratio (SNR), despite relatively good signal strength. As described with respect to FIGS. 2 and 3, the present invention provides a solution to this problem by providing a plurality of channels, phased relative to one another, such that reader 14 includes additional channel diversity. Controller 12 determines which of the respective channels provides the highest quality signal (e.g., highest SNR) and selects this channel for decoding of the data transmitted by RFID tag 20.

FIG. 2 is a block diagram illustrating an exemplary embodiment of RFID reader 14. In this embodiment, RFID reader 14 includes four channels (designated here as channels I, Q, I′, and Q′). RFID reader 14 includes local oscillator 26, phase shifters 28, 30, and 32, and channels I, Q, I′ and Q′. Each respective channel includes a mixer 34a, 34b, 34c and 34d, respectively, a filter 36a, 36b, 36c and 36d, respectively, and an amplifier 38a, 38b, 38c, and 38d, respectively.

Demodulation of the backscattered signal includes mixing the backscattered signal with a local oscillator (LO) signal having a frequency similar to the carrier frequency of the backscattered signal. Mixing of the backscattered signal with the LO signal allows the data modulated by RFID tag onto the carrier frequency to be isolated and recovered. In the embodiment shown in FIG. 2, RFID reader 14 includes a dedicated local oscillator 26. In other embodiments, a dedicated local oscillator is not required within RFID reader 14. Rather than a dedicated local oscillator, the LO signal is derived from the transmitted signal provided by RFID reader 14 to RFID tag 20.

The backscattered signal received by reader antenna 16 is mixed with a LO signal (either provided by local oscillator 26, or derived from the transmitted signal). With respect to channel I, the reflected signal is mixed with a LO signal in-line or in-phase with local oscillator 26 by mixer 34a. The mixed signal is filtered by low-pass filter 36a to remove high-frequency components (e.g., carrier frequency, other forms of downconverted interference, and out-of-band noise), thereby demodulating the backscattered signal such that the data encoded by RFID tag 20 can be discerned. The demodulated signal is provided to amplifier 38a and then to analog-to-digital converter 40 for conversion from an analog signal to a digital signal.

The same process is performed for the remaining three channels, except the phase of the LO signal with which each signal is mixed is varied. With respect to channel Q, the LO signal generated by local oscillator 26 is provided to phase shifter 28 to shift the phase of the LO signal by an amount designated by φ₁ (e.g., 90°). The phase-shifted LO signal is mixed with the backscattered signal by mixer 34b and demodulated by filter 36b, provided to amplifier 38b, and converted to a digital signal by ADC 38. With respect to channel I′, the LO signal generated by local oscillator 26 is provided to phase shifter 30 to shift the phase of the LO signal by an amount designated by φ₂ (e.g., 45°). The phase-shifted LO signal is mixed with the backscattered signal by mixer 34c and demodulated by filter 36c, provided to amplifier 38c, and converted to a digital signal by ADC 38. Finally, with respect to channel Q′, the LO signal generated by local oscillator 26 is provided to phase shifter 32 to shift the phase of the LO signal by an amount designated by φ₃ (e.g., 135°). The phase-shifted LO signal is mixed with the backscattered signal by mixer 34d and demodulated by filter 36d, provided to amplifier 38d, and converted to a digital signal by ADC 38.

Controller 12 determines which of the plurality of channels (e.g., I, Q, I′, and Q′) is of the highest quality and relies on this channel for decoding of data provided by the RFID tag. In an exemplary embodiment described with respect to FIG. 3, below, controller 12 calculates the signal-to-noise ratio associated with each channel and selects the channel having the highest SNR value. In other embodiments, controller 12 may employ other methods of selecting a channel, such as selecting the channel having the highest overall signal strength.

In an exemplary embodiment, the phase shift associated with each channel is devised such that the phase difference between each channel is the same. For example, in the exemplary embodiment described with respect to FIG. 2, four channels were employed, resulting in a phase-shift of 45° between channels I and I′ and between channels Q and Q′. In other embodiments, in which a greater number of channels are employed, the phase difference between each channel can be modified to maintain an equal phase shift between each adjacent channel.

One benefit of the present invention over prior art methods that employ an I-Q channel is the ability to select signals with better signal to noise ratios. Typical systems employ I-Q channels to prevent a worst-case scenario associated with single channel systems in which it is possible for the backscattered signal to be 90° out-of-phase with the LO signal. That is, the signal strength on the channel has the possibility of being equal to zero for a particular phase of the LO signal. By phase-shifting the LO signal, this problem is overcome because at least one of the channels will be (at least partially) in-phase with the backscattered signal such that sufficient signal strength is present for detection. However, this method does not account for the presence of noise on a particular channel, which may exist on the same channel as that employed to detect the desired backscattered signal. In this case, although the signal strength on a particular channel is good, the overall SNR may still be poor.

The present invention overcomes this problem by adding additional channels (i.e., channel diversity), thereby reducing the likelihood of a situation in which the only channel with sufficient signal strength is also the channel dominated by noise. In the exemplary embodiment shown in FIG. 2, four channels were employed to describe the principle of operation of RFID reader 14, although in other embodiments a plurality of channels (e.g., four or more) may be employed to provide the channel diversity necessary to ensure that a channel having good SNR can be found.

FIG. 3 is a flowchart illustrating an exemplary embodiment of the steps performed by controller 12 (e.g., microprocessor) in selecting from the available channels. In this embodiment, the controller calculates signal-to-noise ratios by first measuring the noise associated with each channel. Subsequent measurement of backscattered signals carrying data from an associated RFID tag can be compared with the stored noise values to determine SNRs for each channel. The channel having the highest SNR is then selected and used to decode data provided by the RFID tag.

In particular, at step 52 controller 12 initializes a channel response. That is, controller 12 instructs RFID reader 14 and reader antenna 16 to transmit an unmodulated carrier frequency. A portion of the unmodulated carrier frequency is reflected by reader antenna 16 (this is not related to the backscattering of a signal by tag antenna 18). The reflected signal represents at least a portion (usually a significant portion) of the noise experienced by RFID reader 14. The reflected signal is processed by RFID reader 14 employing channel diversity. For instance, as described with respect to FIG. 2, the reflected signal is processed by each of the plurality of channels I, Q, I′, and Q′. Because the carrier frequency transmitted by reader antenna 16 is unmodulated, and the reflected signal is similarly unmodulated with tag data, the signal generated as a result of processing on each channel represents the noise signal present on each channel.

At step 54, controller 12 measures the resulting noise signals provided on each of the plurality of channels employed by RFID reader 14. The measured noise values are sampled and stored for use in subsequent steps to calculate SNR. In an exemplary embodiment, controller 12 includes a storage device (not shown) for storing the sampled noise values.

At step 56, controller 12 instructs RFID reader 14 and reader antenna 16 to interrogate local RFID tags. Typically (although not always), this includes modulating the carrier signal with instructions regarding the communication (i.e., data required by the reader, communication protocol employed) between RFID reader 14 and RFID tag 20. In response to the interrogation request (i.e., interrogation signal) by RFID reader 14, RFID tag(s) 20 respond by encoding the requested data within the backscattered signal (i.e., modulating the reflected carrier signal).

At step 58 RFID reader 14 demodulates the backscattered signal using channel diversity (e.g., as described with respect to FIG. 2). For instance, as described with respect to FIG. 2, the backscattered signal is demodulated and processed using four separate channels (I, Q, I′, and Q′). In an exemplary embodiment, the LO signal employed to mix channel I′ is 45° out-of-phase with the LO signal employed to mix channel I, the LO signal employed to mix channel Q is 90° out-of-phase with channel I, and the LO signal employed to mix channel Q′ is 45° out-of-phase with channel Q and 135° out-of-phase with channel I.

At step 60, the resulting demodulated channel response provided to controller 12 is compared with noise values previously measured at step 54 to determine which channel provides the best (i.e., highest) SNR. In this way, this embodiment does not merely select the channel providing the highest signal strength (which may also be the channel that carries the most noise), but the channel that provides the best overall SNR. At step 62, controller 12 selects the channel providing the highest SNR and employs this channel to decode data provided by RFID tag 20.

Although the present invention has been described with reference to preferred embodiments, workers skilled in the art will recognize that changes may be made in form and detail without departing from the spirit and scope of the invention. In particular, examples regarding channel diversity of an RFID reader have been described that employ four channels, each channel phased relative to one another. In other exemplary embodiments, a number of additional channels may be employed by RFID reader to further increase the channel diversity. In addition, other embodiments may make use of a variety of protocols regarding the communication between an RFID reader and an RFID tag. Depending on the protocols used, calculation of noise signals may vary.

1. A radio frequency identification (RFID) reader for processing a signal received by a reader antenna, the RFID reader comprising:
a first channel communicatively coupled to the reader antenna to process the received signal, wherein the first channel mixes the received signal with a LO signal provided at a first phase;
a second channel communicatively coupled to the reader antenna to process the received signal, wherein the second channel mixes the received signal with a LO signal provided at a second phase offset from the first phase;
a third channel communicatively coupled to the reader antenna to process the received signal, wherein the third channel mixes the received signal with a LO signal provided at a third phase offset from the first phase and the second phase; and
a fourth channel communicatively coupled to the reader antenna to process the received received signal, wherein the fourth channel mixes the received signal with a LO signal provided at a fourth phase offset from the first phase, the second phase, and the third phase.

2. The RFID reader of claim 1, wherein the signal received by the reader includes a backscattered signal generated by an RFID tag in response to a transmission signal provided by the RFID reader and a noise signal, wherein the backscattered signal is encoded with data provided by the RFID tag.

3. The RFID reader of claim 2, further including:
a controller communicatively coupled to receive the processed signals provided by each of the first, second, third and fourth channels, wherein the controller selects the channel providing a highest signal-to-noise ratio (SNR) for decoding of the backscattered signal provided by the RFID tag.

4. The RFID reader of claim 3, wherein the controller samples and stores noise values generated by each channel of the RFID reader in response to reflective signals captured by the reader antenna without the presence of a backscattered signal provided by an RFID tag.

5. The RFID reader of claim 4, wherein the reflective signals captured by the reader antenna are comprised, at least in part, of reflections generated by the reader antenna while transmitting a carrier signal used to interrogate RFID tags.

6. The RFID reader of claim 4, wherein the controller compares the stored noise values with the processed signals generated in response to the backscattered signal and the noise signal to calculate the SNR values associated with each channel.

7. The RFID reader of claim 1, wherein the phase offset between the first phase and the second phase is equal to the phase offset between the second phase and the third phase, and the phase offset between the third phase and the fourth phase.

8. A method of processing RFID signals received by a reader, the method comprising:
initializing a channel response by transmitting an initial transmission signal from a reader antenna;
processing noisy reflections generated in response to the initial transmission signal using a plurality of phase-offset channels, wherein each channel is defined by a phase offset in a local oscillation (LO) signal mixed with the reflected signal;
sampling and storing the processed reflections as noise values associated with each channel;
interrogating an RFID tag by transmitting an interrogation signal from the reader antenna to an RFID tag;
processing a signal received by the reader antenna in response to the interrogation signal using the plurality of phase-offset channels employed to process the response to the initial transmission signal, wherein the received signal includes a backscattered signal modulated with data provided by the RFID tag and a noise signal caused by reflections generated in response to the interrogation signal;
measuring signal strength associated with each of the plurality of channels and employing the measured noise values calculated with respect to the initial transmission signal to determine signal-to-noise ratios (SNR) associated with each of the plurality of channels; and
selecting a channel from the plurality of channels providing the highest SNR and decoding information provided by the RFID tag based on the selected channel.

9. The method of claim 8, wherein the initial transmission signal is not modulated with instructions regarding the interrogation of RFID tags, such that the reflections generated in response to the initial transmission signal represents the noise associated with the interrogation signal on each of the plurality of channels.

10. The method of claim 8, wherein each of the plurality of phase-offset channels is separated from adjacent channels by an equal amount of phase shift.

11. A radio-frequency identification (RFID) system comprising:
an RFID tag having an antenna for receiving and reflecting transmitted signals;
an RFID reader having at least one antenna for receiving and transmitting signals and a plurality of phase-diverse channels communicatively coupled to the receiving antenna for processing received signals, wherein each phase-diverse channel employs a mixer for mixing a received signal with a local oscillator (LO) signal phase-shifted with respect to each of the plurality of channels; and
a controller communicatively coupled to the RFID reader for receiving the signals processed by each of the plurality of phase-diverse channels, wherein the controller decodes data provided by the RFID tag based on the processed signals provided by the plurality of phase-diverse channels.

12. The RFID system of claim 11, wherein the controller selectively controls the RFID reader to generate an initial transmission signal that results in a plurality of noisy reflections being capture by the RFID reader antenna, wherein processing of the noisy reflections by the phase-diverse channels and sampling of the processed channels provides noise estimates with respect to each of the plurality of channels.

13. The RFID system of claim 12, wherein the controller selectively controls the RFID reader to generate a subsequent interrogation signal that results in the interrogation of the RFID tag, wherein the RFID tag generates a backscattered signal in response to the subsequent interrogation signal that is encoded with data.

14. The RFID system of claim 13, wherein the controller compares noise estimates generated in response to the initial transmission signal by each of the phase-diverse channels with processed signals generated in response to the backscattered signal to calculate a signal-to-noise ratio (SNR) with respect to each of the phase-diverse channels.

15. The RFID system of claim 14, wherein the controller selects the channel having the highest SNR value for decoding of the data provided by the RFID tag.
